(19) United States
(12) Patent Application Publication
(10) Pub. No.: US 2002/0096640 A1
(43) Pub. Date: Jul. 25, 2002

(54) Magnetic shielding for charged-particle-beam optical systems

(75) Inventor: Keiichi Tanaka, Ageo-city (JP)

Correspondence Address: KLARQUIST SPARKMAN, LLP, One World Trade Center, Suite 1600, 121 S.W. Salmon Street, Portland, OR, 97204-2988, US

(73) Assignee: Nikon Corporation

(21) Appl. No.: 10/021,603

(22) Filed: Dec. 11, 2001

(30) Foreign Application Priority Data
Jan. 19, 2001 (JP) 2001-011133

(51) Int. Cl. G01K 1/08; G21K 5/10; H01J 3/14

(52) U.S. Cl. 250/397; 250/492.22

(57) ABSTRACT

Charged-particle-beam microlithographic exposure apparatus are disclosed that effectively block adverse effects of magnetic fields on the trajectory of the charged particle beam. An exemplary apparatus includes an illumination-optical system and a projection-optical system each contained in a respective vacuum chamber. The apparatus includes at least one magnetic shield structure comprising a superconducting material. A multilayer magnetic shield (including a ferromagnetic body and an electrically conductive body) can be situated outside the magnetic shield structure, with a defined gap therebetween. Such a shield structure can be located, e.g., adjacent a beam-trajectory region in an illumination-optical system between a beam deflector and the reticle, in association with a vacuum chamber of the apparatus, and/or in association with an electromagnetic actuator (e.g., linear motor used to actuate a stage device).

### FIELD

This disclosure pertains to microlithography performed using a charged particle beam. Microlithography involves the transfer-exposure of a micro-pattern, defined on a reticle, to a “sensitive” substrate such as a semiconductor wafer. Microlithography is a key technique used in fabricating microelectronic devices such as integrated circuits, displays, thin-film magnetic pickup heads, and micromachines. Microlithography from a reticle usually is performed with demagnification of the image, as formed on the substrate, relative to the pattern as defined on the reticle. The “sensitive” substrate is any lithographic substrate having an upstream-facing surface that is coated with a material (termed a “resist”) that is imprintable with an aerial image of the pattern as formed by the beam. The charged particle beam can be, for example, an electron beam or ion beam. More specifically, the disclosure pertains to charged-particle-beam microlithography apparatus comprising magnetic shielding so as to reduce perturbations of the trajectory of the charged particle beam caused by certain magnetic fields.

### BACKGROUND

In recent years the progressive integration of semiconductor integrated circuits and other microelectronic devices has required progressively higher pattern-transfer accuracy and precision in the various microlithographic techniques exploited during fabrication of such devices. In view of the current limitations of optical microlithography in meeting these demands, an especially attractive “next generation” microlithography technology involves use of a charged particle beam such as an electron beam or ion beam. Charged-particle-beam (CPB) microlithography offers prospects of substantially greater pattern-transfer resolution for reasons similar to the reasons for which electron microscopy yields substantially greater imaging resolution than optical microscopy.

Because a charged particle beam is readily manipulated by magnetic fields, beam trajectory can be disturbed by extraneous magnetic fields. These extraneous magnetic fields can be from any of various sources such as terrestrial magnetism and/or electromagnetic components situated within the microlithography apparatus itself. Unless blocked, shielded, and/or canceled, these extraneous magnetic fields typically cause unpredictable deviations in beam trajectory, which inevitably reduce lithographic accuracy and precision.

In the case of an electron beam, beam energy is a factor that can determine the magnitude of beam perturbation. Under normal conditions, for example, if the disturbing magnetic field is a few μG (microGauss), then the magnitude of deviation of the electron beam at the substrate is a few rm. Although this magnitude of deviation may appear exceedingly small, it can substantially degrade the accuracy and precision with which the subject microelectronic device can be fabricated.

In view of the concerns summarized above, providing effective magnetic shielding is a key objective in the development of a practical CPB microlithography apparatus. Major factors normally considered in various approaches to magnetic shielding and shield materials are: (1) frequency of the extraneous magnetic field, (2) strength of the extraneous magnetic field, and (3) size of the space to be shielded.

One significant source of extraneous magnetic fields is urban noise and terrestrial magnetism. Normally, the magnitude of these fields is about 10⁻⁷ to 10⁻⁴ T. Terrestrial magnetism has a small alternating-current (ac) amplitude and thus can be regarded as a direct-current (dc) magnetic field of about 500 mG. Performance of shielding targeting terrestrial magnetism is evaluated by considering a volume of space surrounded by a surface equivalent to 5 Gauss and determining how much of this field is reduced by the shielding compared to no shielding.

Magnetic shields can be divided broadly into “outside-in” shields and “inside-out” shields. An outside-in shield is simply placed around a space, in which shielding is desired, to prevent incursion of an outside magnetic field into the space. In the context of CPB microlithography, outside-in shielding can be placed around a vacuum chamber or beam column so as to achieve magnetic isolation of the interior of the chamber or column. An inside-out shield is placed around a magnetic-field source to prevent a magnetic field from the source from escaping outside the shield. In the context of CPB microlithography, inside-out shielding can be placed, for example, around the linear motors that drive the respective stages on which the reticle and substrate are mounted. The specific type of inside-out shielding selected depends upon factors such as properties of the source creating the offending magnetic field, the specific components that are adversely affected by the magnetic field, and the positional relationship of the shield material with the source.

Whenever the disturbing magnetic field is a dc magnetic field that is weaker than terrestrial magnetism or is a variable magnetic field that is weaker than urban noise, shielding is difficult. Such conditions indicate selecting outside-in shielding to shield a device (to be isolated magnetically) from the disturbing magnetic field. An outside-in shield as described above is shown generally in FIG. 9, depicting the relationship between a source of an offending magnetic field and the magnetic shield itself. In the figure, item 201 is a “magnetically susceptible” device or space such as a CPB trajectory or substrate. Surrounding the magnetically susceptible item 201 is the magnetic shield 203. Outside the magnetic shield 203 is an external offending magnetic field 205 (referred to as an “external magnetic field”) created by, e.g., terrestrial magnetism or an external device (linear motor or the like). Incursion of the external magnetic field 205 to the magnetically susceptible item 201 is blocked by the magnetic shield 203.

An electric motor (e.g., linear motor) has many advantages for use in CPB microlithography apparatus, such as highly accurate positionability of an object moved by the motor. Unfortunately, electric motors are notorious for generating magnetic fields that can have undesirable effects on beam trajectory and the like. In a CPB microlithography apparatus, it is necessary to provide a magnetic shield in association with devices such as linear motors. In other words, whenever a magnetic-field source such as a linear motor is used within the CPB microlithography apparatus, the probability is high that a peripheral component of the apparatus will be substantially affected in an adverse manner by the magnetic field generated by the magnetic-field source. To counter this problem, “inside-out” shielding as described above is employed around the magnetic-field source.

The basic concept of inside-out shielding is shown in FIG. 10, showing the relationship between a magnetic-field source and an inside-out magnetic shield. Shown in the center of FIG. 10 is the magnetic-field source 211 (e.g., a linear motor or the like). A magnetic shield 213 surrounds the source 211. Magnetically susceptible devices (e.g., the lithographic substrate; not shown) are situated outside the magnetic shield 213. A disturbing magnetic field 21 5 created by the source 211 is blocked by the magnetic shield 213 and thus does not reach the magnetically susceptible devices.

Several types of magnetic shields currently are available, as discussed below. These types are: (1) a direct-current (dc) magnetic shield configured as a ferromagnetic body (“dc shield”), (2) an alternating-current (ac) electromagnetic shield configured as a electrically conductive body (“ac shield”), and (3) an active magnetic shield (cancellation coil).

With respect to the dc shield, a ferromagnetic “body” (e.g., conforming sheet or plate structure) is most commonly used in association with various electrical devices, especially for shielding low-magnitude dc magnetic fields. A ferromagnetic body is effective for shielding not only dc magnetic fields but also terrestrial magnetism, which produces long-period magnetic field fluctuations (a few mHz, 100 nT), and the like. When configuring a shield (e.g., as a shield around a room) using a ferromagnetic body, the method depicted in FIG. 9 normally is employed. By placing the device 201 to be shielded within the shield 213, the device 201 is magnetically isolated from the disturbing magnetic field 205. A shielded room can be used, for example, for containing an apparatus used for measuring very weak magnetic fields.

On the other hand, when providing a magnetic shield for an object such as an electrical transformer, an electric motor, a generator, or an electromagnet, for example, the inside-out shielding method depicted in FIG. 10 is used to shield the source 211 creating the offending magnetic field from regions displaced from the source. In such a shielding scheme, the “core” of the device 211 serves as a magnetic circuit through which most of the magnetic flux passes. The core can be configured so as to function simultaneously as an inside-out magnetic shield serving to prevent escape of the magnetic field. The core also can function as a structural member and/or support member for the source 211.

To improve the performance of a magnetic shield configured as a ferromagnetic body, the selected shield material should have a high relative magnetic permeability μᵣ (the ratio of the magnetic permeability of the material to the magnetic permeability of a vacuum). In this regard, consider a dc magnetic-field shield coefficient S with respect to a magnetic field produced by a source such as terrestrial magnetism. The shield coefficient can be expressed as follows, according to the shape of the shield material. In these expressions, “t” is the thickness of the shield material.

Diameter D of infinite cylinder: S=1+t·μᵣ/D

Diameter D of sphere: S=1+4/3·t·μᵣ/D

One side L of a cube: S=1+0.8·t·μᵣ/L

As indicated above, the performance of the magnetic shield is proportional to the relative magnetic permeability μᵣ of the shield.

Whenever external magnetic fields are shielded using a ferromagnetic body configured as a cylinder or a hollow sphere, the relative magnetic permeability μᵣ of the ferromagnetic body is usually a few thousand to a few tens of thousands. With such a shield, the magnetic flux of an external magnetic field enters and propagates within the shield material, which has low magnetic resistance. A relatively small amount of the flux penetrates through the shield into the space surrounded by the shield material. For example, consider a shield configured as a cylinder having an outside diameter OD, wherein t=¼(OD) and μᵣ=10000 at maximum magnetic permeability. If such a shield is used to shield an external magnetic field of 500 mG, the shield coefficient S (expressed as the ratio of the external magnetic field and the magnetic field inside the shield) is about 1100. As described previously, the shield coefficient S is essentially proportional to μᵣ, but μᵣ is limited by the maximum magnetic permeability of the shield. Consequently, there is a critical value for the shield coefficient S. In this example the critical value is about 2500.

Selecting a desirable shield material is based on the strength of the external magnetic field, the required shield performance, operational factors, and the like. The relative magnetic permeability, μᵣ, decreases as stress is applied to the shield member. Consequently, consideration also should be given to processing and operational parameters.

With respect to an ac shield, magnetic shielding against ac magnetic fields employs eddy currents that are produced in an electrically conductive body due to electromagnetic induction. Consider an ac magnetic field (having an angular frequency ω) applied parallel to the surface of an electrically conductive body (having an electrical conductivity σ and a magnetic permeability μ). Because of skin effects the magnetic field is attenuated to 1/e (wherein “e” is the base of natural logarithms) at a depth at which the skin depth δ=[2/ω·σ·μ)]^{½}. For example, the skin depth δ is 30 mm whenever a magnetic field (having a commutation frequency of 5 Hz from a linear motor) is applied to a copper plate (σ=5.7×10⁷ (Ω·m)⁻¹, μᵣ=1). Whenever a magnetic field having a commutation frequency of 10 Hz is applied to such a plate, the skin depth δ=21 mm. By way of another example, the skin depth δ=1.6 mm whenever a magnetic field (having a commutation frequency of 5 Hz from a linear motor) is applied to a copper plate (σ=1.0×10⁷ (Ω·m)⁻¹, μᵣ=2000). Whenever a magnetic field having a commutation frequency of 10 Hz is applied to such a plate, the skin depth δ=1.1 mm.

Thus, magnetic shielding using eddy currents operates with greater effectiveness with an increase in the frequency of the ac magnetic field, or with increases in the electrical conductivity σ and magnetic permeability μ of the electrically conductive body. Hence, this shielding approach often is selected for shielding an ac magnetic field having a frequency in the electromagnetic-wave region. A magnetic shield in this case is usually called an “electromagnetic shield.”

Electromagnetic shields can be configured as a plate or sheet, and may include one or more short-circuit coils as electrically conductive bodies of the shield (these coils are termed “cancellation” coils). The plate configuration exhibits good shield properties and is often used. Alternatively, the coil approach may be selected depending upon factors such as structure, mass, and required shield properties. Also, the flow of eddy currents in an electrically conductive body is accompanied by Joule loss, which generates heat in the shield. The resulting temperature rise in the electrically conductive body can be a problem.

Incidentally, whenever the frequency of the external magnetic field Hₑ exceeds 10 kHz, the shield enters the category of electromagnetic-wave shielding. Under such conditions employing a metallic material having a high electrical conductivity provides effective shielding.

Further with respect to an ac shield, it is necessary to consider the frequency dependency of the magnetic permeability of the shield material as well as the intrinsic resistance p of the shield material. For example, an ac magnetic shield can be made using a non-magnetic but electrically conductive material such as copper or aluminum. However, if the frequency of the external magnetic field is less than 10 kHz the skin depth of the shield is usually too deep for realizing effective magnetic shielding. Hence, whenever the frequency of the external magnetic field is low, materials of choice include Permalloy PC (a material exhibiting high magnetic resistivity to reduce the skin depth), 3% Si electrical steel sheet, or an amorphous alloy of one or more metals such as iron, nickel, cobalt, for example. (Any of various materials could be used, of which the listed materials are examples.) The shield coefficient S for one layer of an ac shield plate is S=e.

In the shielding approaches discussed above, “passive” magnetic shielding is provided by suitably disposing a magnetic body or electrically conductive body in space relative to the magnetic-field source. In contrast, an “active” magnetic shield utilizes a separate coil (cancellation coil) placed around a magnetic-field creation source (e.g., a coil that creates the main magnetic flux). A flow of electrical current in the cancellation coil reduces or eliminates the magnetic field created by the magnetic-field creation source. If this approach is utilized in a scheme in which feedback is provided (e.g., using a magnetic sensor) to the current flowing in the cancellation coil, the scheme is termed “active cancellation.” Similarly, a scheme that does not exploit such feedback is termed “passive cancellation.”

Advantages of the active-magnetic-shield approach are as follows:

(1) By changing the configuration of the cancellation coil one can obtain better shielding performance than obtained using a ferromagnetic body alone; (2) the mass of a cancellation coil is relatively small; and (3) shield characteristics do not depend upon the strength of the external magnetic field, in contrast to using a ferromagnetic body or a diamagnetic body. Consequently, an active magnetic shield can provide effective shielding against a magnetic field of 1.5 T or 2.0 T, for example.

The various shields discussed above have several disadvantages, however. Simply attaching any one of these magnetic-shield structures to a CPB microlithography apparatus or component thereof does not provide adequate blockage of offending magnetic fields.

For example, a magnetic-shield structure employing a ferromagnetic (e.g., iron) body exhibits problems such as residual magnetic fields in the material, iron loss due to ac magnetic fields, and high mass. These are serious problems especially in instances involving extremely strong or weak magnetic fields. Also, the shield coefficient S of a ferromagnetic body is limited to a few thousand without taking into account the effect of magnetic-flux leakage from ends of the shield structure. Hence, this approach is not always effective in providing the level of high-performance shielding currently required (depending upon the shield's target and objective).

Furthermore, an ac electromagnetic shield (ac shield) employing an electrically conductive body does not provide adequate shielding of dc magnetic fields or low-frequency ac magnetic fields, especially in view of current shielding requirements.

Shield performance of an active-cancellation shield depends upon coil size and shape. Hence, to obtain high shielding performance, the coil(s) should have a certain size and shape for use in a CPB microlithography apparatus. However, space in such an apparatus tends to be very limiting. If insufficient space is available to accommodate the coils, use of this approach can be extremely difficult. Also, whenever this approach is considered for use in a CPB microlithography apparatus, it is necessary to provide feedback using an extremely high-resolution magnetic sensor. Hence, this approach is difficult to utilize in a CPB microlithography apparatus.

### SUMMARY

In view of the disadvantages of conventional shielding approaches as summarized above, the present invention provides, inter alia, shielding approaches that reduce unwanted effects of disturbing magnetic fields on the CPB trajectory and thus increase the accuracy and precision of microlithographic pattern transfer.

A first aspect of the invention is directed to CPB microlithography apparatus having improved magnetic shielding. An embodiment of such an apparatus comprises, along an optical axis, an illumination-optical system and a projection-optical system. The illumination-optical system is situated and configured to illuminate a selected region of a reticle that defines a pattern to be transferred to a sensitive substrate using a charged particle beam. The projection-optical system is situated downstream of the illumination-optical system and is configured to project and focus the charged particle beam, after the beam has passed through the selected region of the reticle, onto a selected corresponding region on the sensitive substrate. The apparatus also comprises a magnetic shield structure including a superconductor material and having a tubular configuration in surrounding relationship to a portion of a beam-trajectory path upstream of at least one of the reticle and substrate. Disposing a magnetic shield structure having a tubular configuration and comprising a superconductor in surrounding relationship to a portion of the beam trajectory blocks external magnetic fields such as terrestrial magnetism and higher-harmonic electromagnetic noise and the like generated from devices such as linear motors.

The apparatus can further comprise a multilayer shield structure that comprises a ferromagnetic body and an electrically conductive body situated radially outside the magnetic shield structure, with a fixed open gap between the magnetic shield structure and the multilayer shield structure. This configuration is effective in reducing the absolute amount of external magnetic field reaching the magnetic shield structure, with a corresponding improvement in shield performance.

Another CPB-microlithography apparatus embodiment comprises an illumination-optical system enclosed in a first vacuum chamber and a projection-optical system enclosed in a second vacuum chamber downstream of the first vacuum chamber. In this configuration, at least one of the vacuum chambers is defined by walls that comprise a superconducting material. Alternatively or in addition to the stated configuration of at least one of the vacuum chambers, a multilayer magnetic shield structure can be situated outside the at least one vacuum chamber (with a fixed gap therebetween), wherein the multilayer magnetic shield structure comprises a ferromagnetic body and an electrically conductive body. Further alternatively to the stated configuration of at least one of the vacuum chambers, a magnetic shield structure can be situated outside at least one of the vacuum chambers (with a fixed gap therebetween), wherein the magnetic shield structure comprises a superconducting material. Any of these vacuum chamber configurations blocks terrestrial magnetism and external magnetic fields such as higher-harmonic electromagnetic noise and the like generated from devices outside the vacuum chamber. In addition, disposing the multilayer magnetic shield outside the magnetic shield structure (with a fixed gap therebetween) reduce the absolute amount of an external magnetic field reaching the magnetic shield structure.

Another CPB-microlithography apparatus embodiment comprises a charged-particle-beam optical system and at least one stage device. The stage device comprises an electromagnetic actuator for driving the stage device, and a magnetic shield structure. The magnetic shield structure comprises a superconductor, and surrounds at least a portion of the actuator with a fixed open gap between the actuator and the magnetic shield structure. The actuator normally is situated near the beam trajectory. An unshielded actuator can have a substantial deleterious effect on the beam trajectory. Disposing the magnetic shield structure in the manner according to this embodiment blocks magnetic fields such as higher-harmonic electromagnetic noise and the like, generated from the actuator, from reaching the beam trajectory.

The apparatus can further comprise a multilayer magnetic shield surrounding at least a portion of the magnetic shield structure. The multilayer magnetic shield comprises a ferromagnetic body and an electrically conductive body, and is situated outside the magnetic shield structure with a defined open gap therebetween. This configuration reduces the absolute amount of magnetic field reaching the magnetic shield structure, thereby improving shield performance. Although low-frequency magnetic field fluctuations (arising, for example, when the stage device changes velocity) sometimes can be ignored, higher-frequency ac magnetic-field fluctuations generated during stage-position-control movements usually magnetic shielding that includes an electrically conductive body.

The foregoing and additional features and advantages of the invention will be more readily apparent from the following detailed description, which proceeds with reference to the accompanying drawings.

### BRIEF DESCRIPTION OF THE DRAWINGS

FIG. 1 is an elevational schematic diagram of an electron-beam (as an exemplary charged particle beam) microlithography apparatus according to a first representative embodiment.

FIG. 2 is a plot of the temperature dependency of the critical magnetic field of a superconductor, described in connection with the first representative embodiment.

FIG. 3 is a transverse section of one of the vacuum chambers (optical column or wafer chamber) of the apparatus of FIG. 1, wherein the chamber is provided with a magnetic shield comprising a superconductor, as described in the second representative embodiment.

FIG. 4 is a transverse section of one of the vacuum chambers (optical column or wafer chamber) of the apparatus of FIG. 1, wherein the chamber is provided with a magnetic shield structure including a magnetic shield comprising a superconductor, and a multilayer shield surrounding the magnetic shield, as described in the third representative embodiment.

FIG. 5 is a plan view of the XY stage device described in the fourth representative embodiment.

FIG. 6 is a longitudinal elevational section of a fixed guide of the stage device of FIG. 5.

FIG. 7 is a transverse elevational section along the line A-A′ in FIG. 6.

FIG. 8 is a transverse elevational section of a linear motor of the stage device of FIG. 5, wherein the linear motor includes a magnetic shield structure.

FIG. 9 schematically depicts certain principles of a conventional “outside-in” shielding scheme.

FIG. 10 schematically depicts certain principles of a conventional “inside-out” shielding scheme.

### DETAILED DESCRIPTION

The invention is described below in the context of representative embodiments, which are not intended to be limiting in any way.

First Representative Embodiment

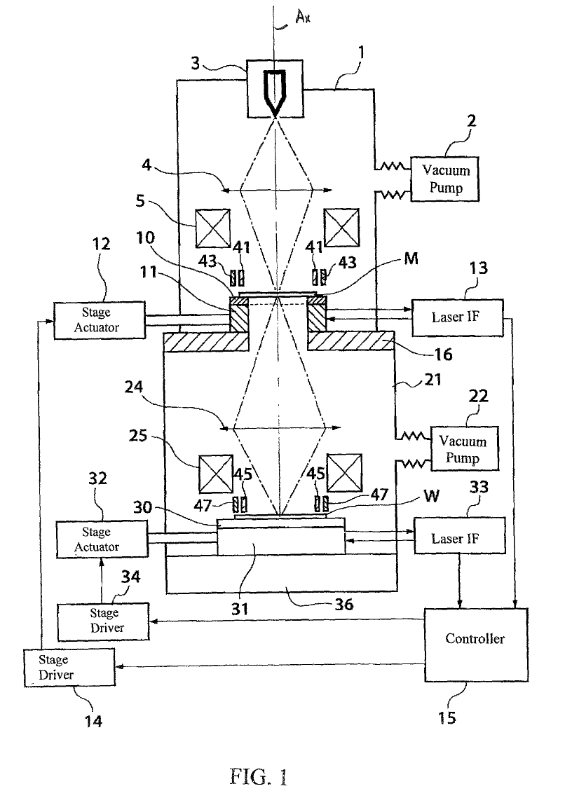

This embodiment is directed to an electron-beam (as an exemplary charged particle beam) microlithography apparatus, which is depicted schematically in FIG. 1.

The depicted apparatus includes an optical column 1, which is evacuated to a desired vacuum level using a vacuum pump 2 connected to the optical column. Hence, the optical column 1 is essentially a “vacuum chamber.” An electron gun 3 is situated at the upstream end of the optical column 1. The electron gun 3 emits an electron beam that propagates in a downstream direction along an optical axis Ax. Disposed downstream of the electron gun 3 are, in sequence, a condenser lens 4, a beam deflector 5, and a reticle M.

The electron beam emitted from the electron gun 3 is converged on the reticle M by the condenser lens 4. The beam is sequentially scanned in the lateral direction by the beam deflector 5 so as to illuminate individual exposure units (termed “subfields”) on the reticle M. Hence, the beam propagating between the electron gun 3 and the reticle M is termed an “illumination beam” and the electronoptical system between the electron gun 3 and the reticle M is termed the “illumination-optical system.”

The reticle M is secured to a chuck 10 mounted on an upstream-facing surface of a reticle stage 11. The chuck 10 holds the reticle M typically by electrostatic attraction. The reticle stage 11 is mounted on a base plate 16.

In this embodiment a magnetic shield 41, comprising a superconductor material in a tubular configuration, circumferentially surrounds a portion (desirably as much as required in view of prevailing physical constraints) of the trajectory region of the illumination beam between the beam deflector 5 and the reticle M. (Details regarding the superconducting materials are described later below.) Situated radially outside the magnetic shield 41 is a “multilayer shield” 43 including a ferromagnetic body (as one layer) and an electrically conductive body (as another layer). The multilayer shield 43 is separated from the magnetic shield 41 by a defined radial gap. The shields 41, 43 serve as, inter alia, “outside-in” shields for shielding external magnetic fields. By way of example, the shields 41, 43 have an axial length of several tens of mm, the radial gap between them is several tens of mm, and the shield diameter is 300-500 mm. An exemplary axial distance of the shields from the reticle stage 11 is several tens of a mm, and an exemplary shield thickness is several mm.

The reticle stage 11 is connected to a stage actuator 12 connected to a controller 15 via a stage driver 14. Position data concerning the reticle stage 11 is obtained by at least one laser interferometer 13 that is connected to the controller 15. Data from the laser interferometer 13 is routed to the controller 15. The controller 15 processes the data and, based on the data, produces appropriate reticle-position commands that are routed to the stage driver 14. The stage driver 14 produces and routes appropriate power to the stage actuator 12. Thus, the position of the reticle stage 11 is feedback-controlled accurately and in real time.

The optical column 1 is connected to a wafer chamber 21 depicted downstream of the base plate 16. The wafer chamber 21 is connected to a vacuum pump 22, which establishes a specified vacuum level in the wafer chamber 21. Hence, the wafer chamber is a “vacuum chamber.” Disposed inside the wafer chamber 21 are, in sequence, a condenser lens 24, a beam deflector 25, and a lithographic substrate (“wafer”) W. The optical components situated between the reticle M and the wafer W constitute the “imaging-optical system,” and the electron beam propagating through the imaging-optical system is termed the “imaging beam” or “patterned beam.”

The patterned beam (carrying an aerial image of the pattern portion illuminated by the illumination beam) is converged by the condenser lens 24. The patterned beam also is deflected as required by the beam deflector 25 to imprint the aerial image at the desired location on the wafer.

The wafer W is secured to a chuck 30 mounted on an upstream-facing surface of the wafer stage 31 by electrostatic attraction. The wafer stage 31 is movable relative to a base plate 36.

In this embodiment a magnetic shield 45, comprising a superconductor material in a tubular configuration, circumferentially surrounds a portion (desirably as much as required in view of prevailing physical constraints) of the trajectory region of the patterned beam between the beam deflector 25 and the wafer W. Situated radially outside the magnetic shield 45 is a multilayer shield 47 including a ferromagnetic body (as one layer) and an electrically conductive body (as another layer). The multilayer shield 47 is separated from the magnetic shield 45 by a defined radial gap. The shields 45, 47 serve as, inter alia, “outside-in” shields for shielding external magnetic fields. By way of example, the shields 45, 47 have an axial length of several tens of mm, the radial gap between them is several tens of mm, and the shield diameter is 300-500 mm. An exemplary axial distance of the shields from the wafer stage 31 is several tens of a mm, and an exemplary shield thickness is several mm.

The ferromagnetic body of the multilayer shield 47 (as well as the multilayer shield 43) has a “high” magnetic permeability and “low” saturation magnetic flux density (e.g., Permalloy PC or PB) or a “low” magnetic permeability and “high” saturation magnetic flux density (e.g., Si steel). (In this context, “high” is greater than 5000 and “low” is everything else.) The electrically conductive body of the multilayer shield 47 (as well as of the multilayer shield 43) is a non-magnetic metal such as copper or silver.

The wafer stage 31 is connected to a stage actuator 32 connected to the controller 15 via a stage driver 34. Position data concerning the wafer stage 31 is obtained by at least one laser interferometer 33 that is connected to the controller 15. Data from the laser interferometer 33 is routed to the controller 15. The controller 15 processes the data and, based on the data, produces appropriate wafer-position commands that are routed to the stage driver 34. The stage driver 34 produces and routes appropriate power to the stage actuator 32. Thus, the position of the wafer stage 31 is feedback-controlled accurately and in real time.

The respective locations and specific configurations of the magnetic shields 41, 43, 45, 47 are not limited to the respective descriptions above. Any of various modifications are possible, depending upon shielding requirements. Furthermore, each of the shields 41, 45 includes a superconductor-circulating device (not shown) by which a superconducting fluid is circulated as a coolant and cooled to below the critical temperature of the superconducting fluid.

A magnetic shield can include a ferromagnetic body and a diamagnetic body. The ferromagnetic body has a relative magnetic permeability μᵣ=1000, for example, and the diamagnetic body has a relative magnetic permeability μᵣ=1/1000, for example. Between these two bodies the magnetic permeability is different, but the shield coefficients S of the shields are equal. Among ferromagnetic bodies no material is known having an infinitely large magnetic permeability; even Permalloy (which has a relatively high magnetic permeability) has a magnetic permeability of a few tens of thousands. On the other hand, with respect to diamagnetic bodies, superconductors are known that intrinsically exhibit perfect diamagnetism with zero magnetic permeability under a magnetic field. If such a superconductor were used, it would be theoretically possible to provide a complete magnetic shield. In practice, however, there are limits to the magnitude of magnetic flux density of an external magnetic field at which perfect diamagnetism is exhibited (“Meissner effect”). Other limitations include the difficulty of magnetically shielding a relatively large space and the difficulty of processing the ends of a magnetic-shield structure.

In this embodiment, emphasis was given to obtaining superior shield performance especially against low magnetic fields. Extremely weak magnetic fields were measured while using magnetic shields configured for extremely weak magnetic fields. The shields included superconductors such as niobium, as well as magnetic-shield structures employing oxide-type high-temperature superconductors.

Also investigated was magnetically shielding relatively strong magnetic fields by utilizing the strong magnetic-flux-pinning ability of type II superconductors to achieve equivalently high diamagnetism. For example, bulk superconductors such as yttrium (Y) and the like made by fusion methods were considered.

Turning now to the temperature dependency of a superconductor's critical magnetic field, even if a weak magnetic field H were applied to a bulk sample that is in a superconducting state, the magnetic field would not penetrate into the interior. Also, even if the temperature of a superconductor placed in a weak magnetic field were lowered, at the critical temperature T_{c} the magnetic field would be excluded and the magnetic flux density B inside the superconductor would be zero. In the following analysis, the vacuum magnetic permeability is denoted μ₀, the magnetic field is denoted H, and magnetization is denoted M. The magnetic flux density B=μ₀ (H+M). Whenever B=0, M=−H and the external magnetic field is cancelled, and the magnetic susceptibility χ=M/H=−1. This phenomenon was discovered by Meissner and Ochsenfeld in 1933, and is known as the Meissner effect (or “perfect diamagnetism”). Because of the Meissner effect, magnetization M is caused by macro-diamagnetic currents flowing at the surface of the sample. This is clearly different from Lenz's law, and does not involve the history of changes pertaining to magnetic fields and temperature.

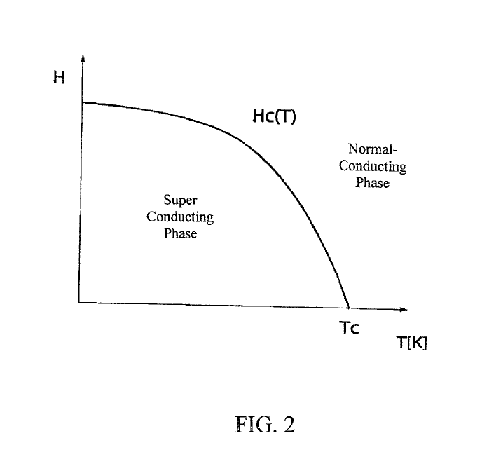

The temperature-dependence of a superconductor's critical magnetic field is depicted in FIG. 2, which is a plot of temperature (T) versus magnetic field (H) for the critical magnetic field H_{c}(T). The region under the critical magnetic field H_{c}(T) curve is the superconducting phase; the area outside the curve is the normally conducting phase. With an increase in the external magnetic field H, the superconducting state breaks down and reverts to a normally conducting state. Hence, the external magnetic field at the superconductor needs to be made as small as possible to maintain a superconducting state near the critical temperature T_{c}.

Therefore, in this embodiment the external magnetic field is made as small as possible by placing the multilayer shields (each including a ferromagnetic body and an electrically conductive body) radially outside the respective magnetic shields (see FIG. 1), and maintaining a fixed gap therebetween.

By configuring each multilayer shield 43, 47 as having a multilayer configuration, substantially improved shield performance is realized in magneticfield regions in which magnetic saturation is not a problem, even when the thickness of a multilayer shield member is essentially the same as of a single-layer shield member.

Consider an example in which a multilayer shield 43, 47 has a cylindrical configuration. If the thickness (t) of the shield is ¼ the maximum outer diameter R of the cylinder, then configuring the shield with two layers improves shielding performance to about 35 dB (about 59 times the shielding performance of a single layer), and configuring the shield with three layers improves shielding performance to about 23 dB (about 14 times the performance of a double layer). The shield member 43, 47 can comprise a plurality of layers of different shield materials that match the magnetic field parameters. Also, the respective thickness ratios of the constituent layers can be changed.

However, configuring the multilayer shields 43, 47 with an excessive number of layers can cause problems, such as excess complexity of the structure, leakage of magnetic fields from seals and joints, and excessive cost. Hence, from a practical standpoint, two to three layers is optimal.

According to this embodiment, an exemplary layered configuration is, in sequence from the side at which the magnetic field is being generated, a ferromagnetic-body layer of a material having a low magnetic permeability and a high saturation magnetic flux density (e.g., Si steel), at least one ferromagnetic-body layer of a material having a high magnetic permeability and a low saturation magnetic flux density (e.g., Permalloy PC or PB), and an electrically conductive-body layer (e.g., copper or silver), with a fixed open gap between each layer. An exemplary gap is several mm to several tens of mm, depending upon the application.

Second Representative Embodiment

In this embodiment the walls of the respective vacuum chambers constituting the optical column 1 and the wafer chamber 21 (FIG. 1) are respective magnetic-shield structures each comprising a superconductor. Also, a multilayer shield structure comprising a ferromagnetic body and an electrically conductive body is disposed outside these vacuum chambers, with a fixed open gap between the respective shield structures. An exemplary gap is several mm to several tens of mm, depending upon the application.

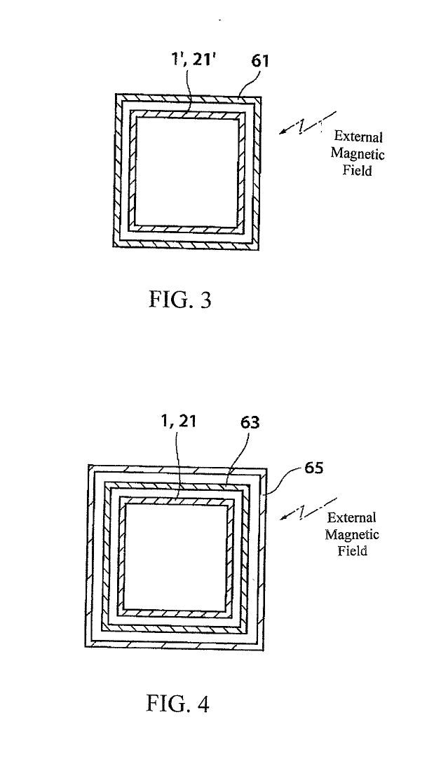

FIG. 3 is a transverse section of one of the chambers 1, 21. In FIG. 3 the wall (including the superconductor) of the vacuum chamber is designated 1′ or 21′ (1′, 21′). The multilayer shield structure comprising a ferromagnetic body and an electrically conductive body is designated as item 61. The respective transverse profiles of the walls 1′, 21′ and multilayer shield structure 61 are square, with a fixed open separation (gap) therebetween. An exemplary gap is several mm to several tens of mm, depending upon the application. This structure is effective in preventing incursion of external magnetic fields into the interior of the respective vacuum chamber 1, 21.

The placement of the multilayer shield structure 61 in this embodiment is not limited to the depicted configuration. For example, the multilayer shield structure 61 alternatively can be disposed at the bottom or top of the respective vacuum chamber 1, 21. Also, the shape is not limited to the depicted square transverse profile. Alternatively, the multilayer shield structure 61 can be configured with a tube-like profile outside the respective vacuum chamber 1, 21.

Third Representative Embodiment

As shown in FIG. 4, in this embodiment a respective magnetic-shield structure 63 comprising a superconductor is situated in surrounding relationship to the respective vacuum chamber 1, 21. In addition, a respective multilayer shield 65 comprising a ferromagnetic body and an electrically conductive body is situated outside the respective magnetic shield structure 63.

In FIG. 4 the vacuum chambers 1, 21 (FIG. 1) are made of steel or the like, as usual. The magnetic-shield structure 63 comprises a superconductor and has a transverse profile that conforms to the transverse profile of the vacuum chamber 1, 21 (but with a defined gap between the shield and the chamber). (An exemplary gap is several mm to several tens of mm, depending upon the application.) Conformably surrounding the magnetic-shield structure 63 is the multilayer shield structure 65 (but with a defined gap, as noted above, between the structures 63, 65). These shield structures provide excellent shielding from incursion of external magnetic fields into the respective vacuum chamber.

The respective disposition locations of the magnetic-shield structure 63 and the multilayer-shield structure 65 are not limited to the depicted configuration. Alternatively, these structures 63, 65 can be disposed above and/or below the respective vacuum chamber 1, 21. Also, with respect to shape, the shield structures 63, 65 alternatively can have a tubular configuration, for example.

Fourth Representative Embodiment

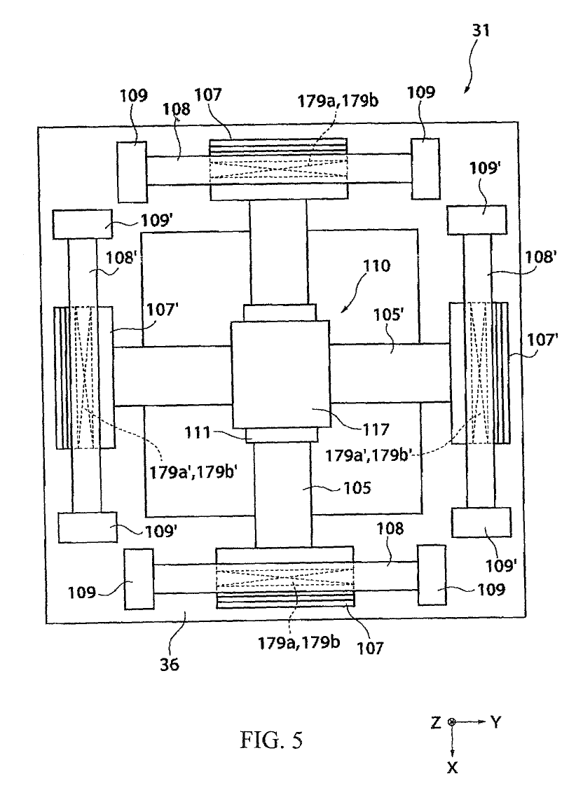

This embodiment is directed to a shielded XY stage device usable with a CPB microlithography apparatus. The stage device (e.g., wafer stage 31) is depicted in plan view in FIG. 5. In the embodiment of FIG. 5 a platform 110 is situated in the middle region of the stage device 31. The platform 110 includes a lower portion 111 and an upper portion 117. The lower portion 111 is driven in the Y-axis direction by respective electromagnetic actuators (linear motors) 179a, 179b, and the upper portion 117 is driven in the X-axis direction by respective electromagnetic actuators (linear motors) 179a′, 179b′. The lower portion 111 and upper portion 117 are coupled together by flexures such as leaf springs, for example (not shown). The platform 110 supports a holding device such as an electrostatic chuck (not shown but well understood in the art). Specifically, the chuck is mounted to the upper portion 117. In the depicted configuration the chuck holds a wafer W (see FIG. 1).

The stage device 31 also includes an X-axis moving guide 105 (extending in the X-axis direction) that engages the lower portion 111 via an air bearing (not shown). A respective Y-axis slider 107 is mounted to each end of the X-axis moving guide 105. The Y-axis sliders 107 slidably engage a Y-axis fixed guide 108, extending in the Y direction, via respective air bearings (not shown). The ends of the Y-axis fixed guide 108 are mounted to the base plate 36 by respective fixed members 109.

The stage device 31 also includes a Y-axis moving guide 105′ (extending in the Y-axis direction) that engages the upper portion 117 via an air bearing (not shown). A respective X-axis slider 107′ is mounted to each end of the Y-axis moving guide 105′. The X-axis sliders 107′ slidably engage an X-axis fixed guide 108′, extending in the X direction, via respective air bearings (not shown). The ends of the X-axis fixed guide 108′ are mounted to the base plate 36 by respective fixed members 109′.

As described in detail later below, linear motors 179a, 179b, are provided on each end of the Y-axis sliders 107, and linear motors 179a′, 179b′ are provided on each end of each of the X-axis sliders 107′. Actuating the linear motors 179a and 179b drives the Y-axis sliders 107 (and the lower portion 111) in the Y direction. Similarly, actuating the linear motors 179a′ and 179b′ drives the X-axis sliders 107′ (and the upper portion 117) in the X direction.

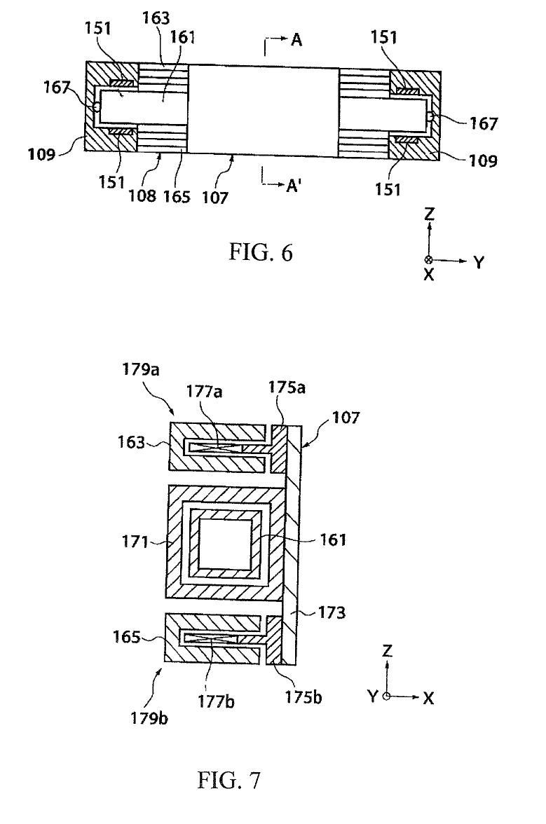

Configurational details of the sliders 107 and fixed guides 108 (for movement in the positive X-axis direction in FIG. 5) are depicted in FIGS. 6 and 7. It will be understood that the sliders 107 and fixed guides 108 (for movement in the negative X-axis direction in FIG. 5) as well as the sliders 107′ and fixed guides 108′ are constructed similarly to what is shown in FIGS. 6 and 7. FIG. 6 is a longitudinal elevational view of the slider 107 and fixed guide 108, and FIG. 7 is a transverse elevational section along the line A-A′ in FIG. 6.

Turning first to FIG. 6, the fixed guide 108 comprises a cylinder guide 161 extending along the longitudinal midline of the fixed guide 108, and magnets 163 and 165 disposed above and below, respectively, the cylinder guide 161. The ends of the cylinder guide 161 are fixed to respective fixed members 109 via respective bearings 167. At each connection of a respective end of the cylinder guide 161 with a respective fixed member 109, a respective air pad (air bearing) 151 is situated above and below. Extending around each air pad 151 is a respective “guard ring” (not shown) configured as a respective groove in the respective inside surface of the fixed member 109. Each such pair of air pads 151 sandwiches the respective end of the cylinder guide 161 from above and below and positions the respective end along a center line of the respective fixed member 109. The magnets 163, 165 have a flat channel configuration longitudinally extending in the Y direction with the respective channel opening extending in the X direction outward from the platform 110.

The slider 107 also engages the cylinder guide 161 via at least one respective air bearing. Turning now to FIG. 7, the central portion of the slider comprises a tubular (desirably square in transverse section) cylinder 171 that engages the cylinder guide 161 in the manner shown. The tubular cylinder 171 is mounted at a center line of a planar slider plate 173 having a defined thickness. T-shaped coil mounts 175a, 175b, each extending in the X direction, are mounted to the slider plate 173 above and below the tubular cylinder 171 and project in the −X direction. Mounted to the terminus of each coil mount 175a, 175b is a respective motor coil 177a, 177b. Each motor coil 177a, 177b has a flat rectangular configuration and fits into the channel opening of the respective magnet 163, 165 to form respective linear motors 179a, 179b for Y-direction driving of the slider 107. The point at which the collective drive forces generated by the linear motors 179a, 179b converge essentially coincides with the center of gravity of the slider 107, which allows extremely accurate positional control and high-speed operation. Although not shown, it will be understood that electrical wiring for energizing the motor coils 177a, 177b, as well as conduits for routing a coolant medium, are attached to or otherwise associated with the slider 107.

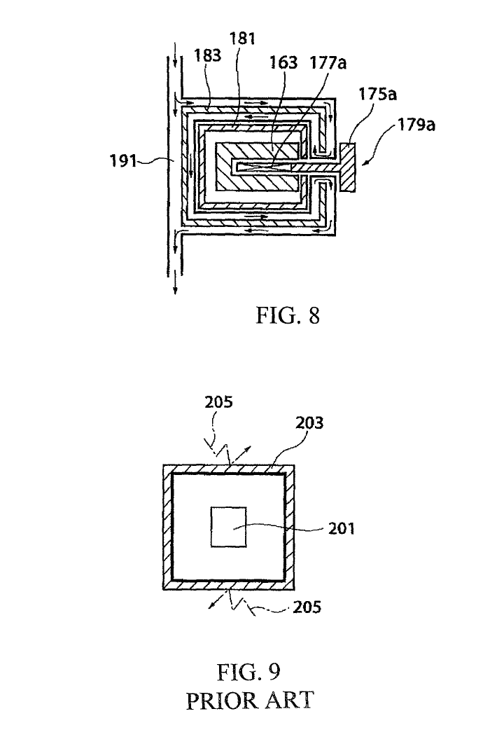

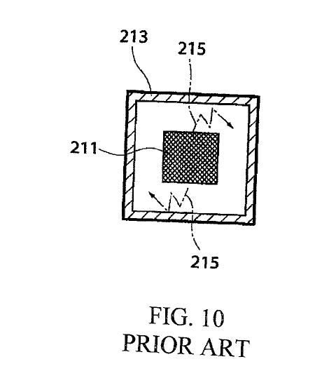

FIG. 8 shows an exemplary magnetic shield, according to this embodiment, for the linear motor. Specifically, FIG. 8 depicts the linear motor (electromagnetic actuator) 179a comprising the coil mount 175a, the motor coil 177a mounted to the end of the coil mount 175a, and the respective magnet 163. A multilayer shield 181 comprising a ferromagnetic body and an electrically conductive body is situated in surrounding relationship to the magnet 163, with a respective fixed open gap therebetween. An exemplary gap is several mm to several tens of mm, depending upon the application. A magnetic shield 183 comprising a superconductor is situated in surrounding relationship to the multilayer shield 181, with a respective fixed open gap, as noted above, therebetween. These shield structures 181, 183 effectively block magnetic fields created by the electromagnetic actuator 179a.

A coolant-circulation path 191 is defined so as to surround and enclose the magnetic shield 183. A conduit (not shown) provides the coolant-circulation path 191 with coolant from an external source (not shown), and removes spent coolant. Coolant supplied from a pipe in the upper part of the drawing flows branchingly to the side and top of the magnetic shield structure 183. In FIG. 8, for example, coolant enters the region of the magnetic shield 183 from the top and circulates first along the outer and inner surfaces of the magnetic shield 183 as shown, then exits at the bottom of the magnetic shield 183. The exiting coolant is returned to the coolant source. The coolant source desirably is a device that re-cools the spent coolant for re-supply to the coolant-circulation path 191. The coolant can be, for example, water. By thus circulating the coolant, the temperature of the magnetic shield 183 can be maintained at a desired low temperature.

It will be understood that the configuration and disposition of the magnetic shield structure comprising the superconductor and the multilayer shield are not limited to those specifically described above. Any of various modifications are possible.

Whereas the invention has been described in connection with multiple representative embodiments, it will be understood that the invention is not limited to those embodiments. On the contrary, the invention is intended to encompass all modifications, alternatives, and equivalents as may be included within the spirit and scope of the invention, as defined by the appended claims.

What is claimed is:

1. A charged-particle-beam microlithography apparatus, comprising along an optical axis:
an illumination-optical system situated and configured to illuminate a selected region of a reticle that defines a pattern to be transferred to a sensitive substrate using a charged particle beam;
a projection-optical system situated downstream of the illumination-optical system and configured to project and focus the charged particle beam, after the beam has passed through the selected region of the reticle, onto a selected corresponding region on the sensitive substrate; and
a magnetic shield structure comprising a superconductor material and having a tubular configuration in surrounding relationship to a portion of a beam-trajectory path upstream of at least one of the reticle and substrate.

2. The apparatus of claim 1, further comprising a multilayer shield structure, comprising a ferromagnetic body and an electrically conductive body situated radially outside the magnetic shield structure, with a fixed open gap between the magnetic shield structure and the multilayer shield structure.

3. The apparatus of claim 1, wherein the magnetic shield structure is coaxial with the optical axis.

4. The apparatus of claim 1, comprising multiple magnetic shield structures, wherein a first magnetic shield structure is situated upstream of the reticle, and a second magnetic shield structure is situated upstream of the substrate.

5. The apparatus of claim 1, wherein:
the illumination-optical system comprises a beam deflector; and
the magnetic shield structure is situated between the reticle and the beam deflector.

6. The apparatus of claim 1, wherein:
the projection-optical system comprises a beam deflector; and
the magnetic shield structure is situated between the substrate and the beam deflector.

7. The apparatus of claim 1, wherein:
the illumination-optical system is enclosed in a first vacuum chamber;
the projection-optical system is enclosed in a second vacuum chamber; and
at least one of the first and second vacuum chambers is defined by walls that comprise a superconductor material so as to provide the walls with a magnetic shielding property.

8. The apparatus of claim 7, further comprising a multilayer magnetic shield structure situated outside the at least one vacuum chamber, the multilayer magnetic shield structure comprising a ferromagnetic body and an electrically conductive body.

9. The apparatus of claim 8, wherein the multilayer magnetic shield structure is separated from the walls of the vacuum chamber by a defined open gap.

10. The apparatus of claim 1, wherein:
the illumination-optical system is enclosed in a first vacuum chamber;
the projection-optical system is enclosed in a second vacuum chamber; and
a magnetic shield structure situated outside at least one of the first and second vacuum chambers, the magnetic shield structure comprising a superconductor material.

11. The apparatus of claim 10, wherein the magnetic shield structure is separated from the at least one vacuum chamber by a defined open gap.

12. The apparatus of claim 10, further comprising a multilayer magnetic shield structure situated outside the magnetic shield structure, the multilayer magnetic shield structure comprising a ferromagnetic body and an electrically conductive body.

13. The apparatus of claim 12, wherein the multilayer magnetic shield structure is separated from the magnetic shield structure by a defined open gap.

14. The apparatus of claim 1, further comprising at least one stage device configured for holding and moving the reticle or substrate, the stage comprising (a) an electromagnetic actuator for driving the stage device, and (b) a magnetic shield structure comprising a superconductor, the magnetic shield structure surrounding at least a portion of the actuator with a fixed open gap between the actuator and the magnetic shield structure.

15. The apparatus of claim 14, further comprising a multilayer magnetic shield surrounding at least a portion of the magnetic shield structure, the multilayer magnetic shield comprising a ferromagnetic body and an electrically conductive body and being situated outside the magnetic shield structure with a defined open gap therebetween.

16. A charged-particle-beam microlithography apparatus, comprising:
an illumination-optical system enclosed in a first vacuum chamber; and
a projection-optical system enclosed in a second vacuum chamber downstream of the first vacuum chamber, wherein at least one of the vacuum chambers is defined by walls that comprise a superconducting material.

17. The apparatus of claim 16, further comprising a multilayer magnetic shield structure situated outside the at least one vacuum chamber, the multilayer magnetic shield structure comprising a ferromagnetic body and an electrically conductive body.

18. The apparatus of claim 17, wherein the multilayer magnetic shield structure is separated from the walls of the vacuum chamber by a defined open gap.

19. The apparatus of claim 16, further comprising at least one stage device configured for holding and moving the reticle or substrate, the stage comprising (a) an electromagnetic actuator for driving the stage device, and (b) a magnetic shield structure comprising a superconductor, the magnetic shield structure surrounding at least a portion of the actuator with a fixed open gap between the actuator and the magnetic shield structure.

20. The apparatus of claim 19, further comprising a multilayer magnetic shield surrounding at least a portion of the magnetic shield structure, the multilayer magnetic shield comprising a ferromagnetic body and an electrically conductive body and being situated outside the magnetic shield structure with a defined open gap therebetween.

21. A charged-particle-beam microlithography apparatus, comprising:
an illumination-optical system enclosed in a first vacuum chamber;
a projection-optical system enclosed in a second vacuum chamber downstream of the first vacuum chamber; and
a magnetic shield structure situated outside at least one of the first and second vacuum chambers, the magnetic shield structure comprising a superconductor material.

22. The apparatus of claim 21, wherein the magnetic shield structure is separated from the at least one vacuum chamber by a defined open gap.

23. The apparatus of claim 21, further comprising a multilayer magnetic shield structure situated outside the magnetic shield structure, the multilayer magnetic shield structure comprising a ferromagnetic body and an electrically conductive body.

24. The apparatus of claim 23, wherein the multilayer magnetic shield structure is separated from the magnetic shield structure by a defined open gap.

25. The apparatus of claim 21, further comprising at least one stage device configured for holding and moving the reticle or substrate, the stage comprising (a) an electromagnetic actuator for driving the stage device, and (b) a magnetic shield structure comprising a superconductor, the magnetic shield structure surrounding at least a portion of the actuator with a fixed open gap between the actuator and the magnetic shield structure.

26. The apparatus of claim 25, further comprising a multilayer magnetic shield surrounding at least a portion of the magnetic shield structure, the multilayer magnetic shield comprising a ferromagnetic body and an electrically conductive body and being situated outside the magnetic shield structure with a defined open gap therebetween.

27. A charged-particle-beam microlithography apparatus for producing an image of a pattern on a surface of a substrate, the apparatus comprising:
a charged-particle-beam optical system; and
at least one stage device comprising (a) an electromagnetic actuator for driving the stage device, and (b) a magnetic shield structure comprising a superconductor, the magnetic shield structure surrounding at least a portion of the actuator with a fixed open gap between the actuator and the magnetic shield structure.

28. The apparatus of claim 27, further comprising a multilayer magnetic shield surrounding at least a portion of the magnetic shield structure, the multilayer magnetic shield comprising a ferromagnetic body and an electrically conductive body and being situated outside the magnetic shield structure with a defined open gap therebetween.

29. In a charged-particle-beam microlithography system, a stage device, comprising:
a platform;
an electromagnetic actuator for driving the platform; and
a magnetic shield structure comprising a superconductor, the magnetic shield structure surrounding at least a portion of the actuator with a fixed open gap between the actuator and the magnetic shield structure.

30. The stage device of claim 29, further comprising a multilayer magnetic shield surrounding at least a portion of the magnetic shield structure, the multilayer magnetic shield comprising a ferromagnetic body and an electrically conductive body and being situated outside the magnetic shield structure with a defined open gap therebetween.

31. In a method for performing charged-particle-beam (CPB) microlithography, wherein a charged particle beam is directed by a CPB optical system to produce an image of a pattern on a location on a sensitive substrate so as to imprint the sensitive substrate with an image of the pattern, a method for shielding the charged particle beam from a magnetic field generated by a magnetic-field source, the method comprising placing a magnetic shield structure between the magnetic-field source and the charged particle beam, the magnetic shield structure comprising a superconducting material configured so as to surround at least a portion of a region of a beam-trajectory path otherwise susceptible to the magnetic field.

32. The method of claim 31, further comprising the step of placing a multilayer shield structure, comprising a ferromagnetic body and an electrically conductive body, between the magnetic shield structure and the magnetic-field source, with a fixed open gap between the magnetic shield structure and the multilayer shield structure.

33. In a method for performing charged-particle-beam (CPB) microlithography, wherein a charged particle beam is directed by a CPB optical system to produce an image of a pattern on a location on a sensitive substrate so as to imprint the sensitive substrate with an image of the pattern, a method for shielding the charged particle beam from a magnetic field generated by a magnetic-field source in the CPB optical system, the method comprising surrounding at least a portion of the magnetic-field source with a magnetic shield structure, the magnetic shield structure comprising a superconducting material.

34. The method of claim 33, further comprising the step of placing a multilayer magnetic shield surrounding at least a portion of the magnetic shield structure, the multilayer magnetic shield comprising a ferromagnetic body and an electrically conductive body and being situated relative to the magnetic shield structure with a defined open gap therebetween.
